(19) United States
(12) Patent Application Publication
(10) Pub. No.: US 2024/0362576 A1
(43) Pub. Date: Oct. 31, 2024

(54) PREDICTIVE TRACKING MANAGEMENT SYSTEM

(71) Applicant: FourKites, Inc., Chicago, IL (US)

(72) Inventor: Karthik Rajagopal, Chicago, IL (US)

(73) Assignee: FourKites, Inc., Chicago, IL (US)

(21) Appl. No.: 18/647,038

(22) Filed: Apr. 26, 2024

Related U.S. Application Data
(60) Provisional application No. 63/462,802, filed on Apr. 28, 2023.

(51) Int. Cl. G06Q 10/0835; G06Q 10/0833

(52) U.S. Cl. CPC G06Q 10/08355; G06Q 10/0833

(57) ABSTRACT

Disclosed are systems, apparatuses, methods, and computer readable medium, and circuits for identifying delay risks in carrier shipping services. A method includes: receiving a pre-shipment notification from a customer indicating that a load will be collected from a source location and delivered to a destination location; determining a collection date to collect the load based on a status of contents of the load; identifying a first carrier and a service level for the load considering a requested delivery date; prior to collection of the load, determining a predicted delivery date for the load based on friction within a transit configuration for the load using the first carrier, wherein the friction is associated with at least one intrinsic constraint of the first carrier and at least one extrinsic constraint; and in response to determining that the predicted delivery date is after the requested delivery date, identifying at least one correction.

### CROSS-REFERENCE TO RELATED APPLICATIONS

This application claims priority to U.S. Provisional Application No. 63/462,802, filed Apr. 28, 2023, the contents of which are hereby expressly incorporated by reference in their entirety and for all purposes.

### TECHNICAL FIELD

The present disclosure generally relates to tracking management systems. In some examples, aspects of the present disclosure are related to a predictive tracking management system.

### BACKGROUND

Supply chain visibility information is generally provided based on existing supply routes of carriers. The supply routes are static and the carriers provide a best-effort service level to deliver packages, parcels, or freight within an estimated delivery window. Carriers typically implement a hub and spoke model to collect packages, parcels, and freight from distributed points, aggregate common destinations, and ship large volumes between the different hubs. The hubs are generally adjacent to a major transit feature, such as an airport, highway, rail station, or port, and process a high volume of packages quickly to ensure efficient delivery. Carrier shipping services can vary significantly based on extrinsic factors that are outside of the carrier's control and intrinsic that the carrier may be limited visibility and awareness of. For example, adverse weather such as flooding can disable a carrier's hub. In these cases, packages with time sensitive materials can be delayed and may adversely affect downstream entities. For example, biological materials can be spoiled based on a delay.

### SUMMARY

In some examples, systems and techniques are described for predicting delays in carrier shipping services. The systems and techniques can visibility and identification of issues in potential shipments in carrier shipping services.

Disclosed are systems, apparatuses, methods, computer readable medium, and circuits for identifying delay risks. According to at least one example, a method includes: receiving a shipment notification from a customer indicating that a load will be collected from a source location and delivered to a destination location; determining a collection date to collect the load based on a status of contents of the load; identifying a first carrier and a service level for the load based on a requested delivery date; prior to collection of the load, determining a predicted delivery date for the load based on friction within a transit configuration for the load using the first carrier, wherein the friction is associated with at least one intrinsic constraint of the first carrier and at least one extrinsic constraint; and in response to determining that the predicted delivery date is after the requested delivery date, identifying at least one corrective modification to the transit configuration for the load. For example, the predictive transport management system receives a shipment notification from a customer indicating that a load will be collected from a source location and delivered to a destination location; determines a collection date to collect the load based on a status of contents of the load; identifies a first carrier and a service level for the load based on a requested delivery date; prior to collection of the load, determines a predicted delivery date for the load based on friction within a transit configuration for the load using the first carrier, wherein the friction is associated with at least one intrinsic constraint of the first carrier and at least one extrinsic constraint; and in response to determining that the predicted delivery date is after the requested delivery date, identifies at least one corrective modification to the transit configuration for the load.

In another example, a predictive transport management system for identifying delay risks is provided that includes a storage (e.g., a memory configured to store data, such as virtual content data, one or more images, etc.) and one or more processors (e.g., implemented in circuitry) coupled to the memory and configured to execute instructions and, in conjunction with various components (e.g., a network interface, a display, an output device, etc.), cause the predictive transport management system to: receive a shipment notification from a customer indicating that a load will be collected from a source location and delivered to a destination location; determine a collection date to collect the load based on a status of contents of the load; identify a first carrier and a service level for the load based on a requested delivery date; prior to collection of the load, determine a predicted delivery date for the load based on friction within a transit configuration for the load using the first carrier, wherein the friction is associated with at least one intrinsic constraint of the first carrier and at least one extrinsic constraint; and, in response to determining that the predicted delivery date is after the requested delivery date, identify at least one corrective modification to the transit configuration for the load.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

In order to describe the manner in which the various advantages and features of the disclosure can be obtained, a more particular description of the principles described herein will be rendered by reference to specific embodiments thereof which are illustrated in the appended drawings. Understanding that these drawings depict only example embodiments of the disclosure and are not to be considered to limit its scope, the principles herein are described and explained with additional specificity and detail through the use of the drawings in which:

FIG. 1 is a block diagram illustrating an example shipment management system, in accordance with some aspects of the disclosure;

FIG. 2 illustrates an example environment for implementing an integrated shipment platform, in accordance with some aspects of the disclosure;

FIG. 3 is a conceptual illustration of predictive tracking management system, in accordance with some aspects of the disclosure;

FIG. 4 is a conceptual block diagram of a predictive tracking management system, in accordance with some aspects of the disclosure;

FIG. 5 is a block diagram illustrating an architecture of a predictive tracking management system, in accordance with some examples;

FIG. 6 is a sequence diagram illustrating operation of a predictive tracking management system, in accordance with some aspects of the disclosure;

FIG. 7 is a block diagram illustrating a conceptual processing pipeline implemented by a predictive tracking management system in accordance with some aspects of the disclosure;

FIG. 8 is a flow diagram of a method for a predictive tracking management system, in accordance with some examples;

FIG. 9 illustrates an example computing device architecture, in accordance with some examples of the present disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously described, customers of carrier shipping services have minimal visibility into a carrier's infrastructure and logistics. A carrier shipping service can provide a best-effort estimate, but the customer will have no visibility into issues, infrastructure, and other adverse issues that could affect a collection and delivery of a load. For example, customers are not aware of the transportation hubs used by carrier shipping services, and each carrier shipping service has a different infrastructure that significantly varies. For example, a customer may be unaware that a cargo plane leaving from a first city to a second city is scheduled to depart at a specific time, and delays due to traffic may affect the delivery of the consigned load to the plane. A customer would be unaware of alternate routes that the load may take if received at the carrier's facility with insufficient time to be loaded onto the cargo plane, and a customer would not be aware that another carrier has a higher delivery rate due to a cargo plane leaving at a later time.

Customers of these carrier shipping services often use delivery times as a key criterion for choosing a carrier. Carriers promise tighter delivery windows to customers to maintain customer relationships, which further strains operations and delivery operations of the carrier. However, not all loads have the same priority or value, and customers are unaware of risks, tolerances, infrastructure, and other factors that may cause a delay. For example, transmission of medical supplies may be critical and a higher chance of a delay due to various factors may be more important than cost or convenience. Delays to some loads can impact customer satisfaction, revenue, research, operations, and potentially lives.

Customers of carrier shipping services have limited visibility of the load in real-time, no ability to identify potential adverse effects that are extrinsic or intrinsic to a carrier, and what actions the customer can to remediate a potentially delayed load.

Disclosed herein are systems, methods, and computer-readable storage media for predicting the adverse issues in a transit configuration of a load. In some examples, the approaches herein can provide a predictive tracking management system that provides visibility into adverse effects and other issues that may affect the shipment of load. The predictive tracking management system can thus provide predicted visibility information, identify potential risks of delay, and in some cases provide various remedies. According to aspects of the disclosure, the predictive tracking management system can identify when a load or order will be ready for consignment, and the predictive tracking management system can identify orders with an acceptable or unacceptable risk of shipment delay. The predictive tracking management system may be configured to identify the risk of shipment delay before consignment to the carrier and during transit with the carrier.

The predictive tracking management system can include a machine learning (ML) model or other artificial intelligence (AI) network that is capable of predicting the route a load (e.g., a package, parcel, or freight) is going to travel from pickup to delivery and/or throughout a trip from pickup to delivery and issues that may adversely affect the transit of the load. The predictive tracking management system may monitor real-time events by using structured data (e.g., using an application programming interface (API) or microservice) and unstructured data (e.g., a news article) to determine potential risks of delay and providing information to a customer before the load is collected (e.g., before consignment) and after the load is collected (e.g., after consignment). The ML model can predict various routes based on information about the load (e.g., load attributes such as the type of load, the weight of the load, load restrictions/constraints, transportation vehicle for the load (e.g., truck, trailer, etc.), appointment time, shipment priority, etc.), information about the carrier (e.g., who is transporting the load, what type of vehicle uses the carrier, etc.), the kind or product being transported in the load (e.g., food, chemical, pharmaceutical, electronics, clothing, etc.), the shipper of the load, the day/time in which the load is being transported, information about the source/origin location and/or the destination (e.g., city, state, country, facility, business hours, distance from source/origin to destination, etc.), historical information (e.g., shipping or carrier patterns or histories, load patterns or histories, industry patterns or histories, source and/or destination patterns or histories, historic usage of different lanes, etc.), the day/time the load was picked up by the carrier, news information, weather information, traffic information, and/or any other relevant information.

Based on the predicted route, the ML model can predict an estimate that the load will be delayed and an estimated delivery date and time. The ML model can also provide a confidence in the estimation and may provide information to the customer that identifies risks. In some aspects, the ML model can also provide suggestions for alternate carriers based on delivery requirements, alternate delivery destinations, alternate shipping originations, and so forth. The ML model can also monitor the load based on the route after consignment to the carrier, and may provide options to remediate a potentially delayed load.

Additional details and aspects of the present disclosure are described in more detail below with respect to the figures.

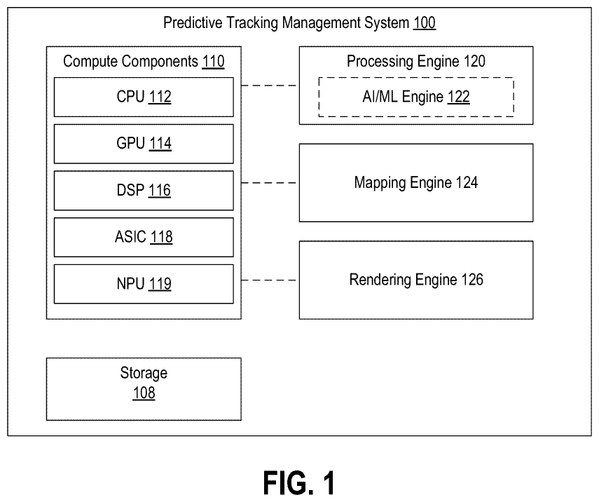

FIG. 1 illustrates an example supply chain management system 100 for automatically managing orders and shipments (e.g., shipment records, orders, shipment data, etc.), tracking shipments and associated data, and providing supply chain visibility and management for freights/loads. As further described herein, the supply chain management system 100 can include, implement, and/or represent a supply chain visibility and management platform and can provide various advantages such as automated data management, timely and robust order and shipment tracking and visibility, workflow management, efficient and timely data and document management, greater consistency and reliability of shipment and tracking information, lower data and shipment management costs, reduced shipping complexities, etc.

In the example shown in FIG. 1, the supply chain management system 100 includes a storage 108, compute components 110, a processing engine 120, an AI/ML engine 122, a document management system 124, and a presentation engine 126. However, it should be noted that the example components shown in FIG. 1 are provided for illustration purposes and, in other examples, the supply chain management system 100 can include more or less components (and/or different components) than those shown in FIG. 1.

The supply chain management system 100 can be part of a computing device or multiple computing devices. In some examples, the supply chain management system 100 can be part of an electronic device (or devices) such as a server, a content management system, a host machine in a network such as a cloud or private network, a computer in a vehicle, a computer node, or any other suitable electronic device(s). In some examples, the supply chain management system 100 can be or can include one or more software services and/or virtual instances hosted on a datacenter or a network environment. For example, the supply chain management system 100 can be implemented by, or as part of, one or more software containers hosted on a datacenter or network (e.g., a cloud, a private network, etc.), one or more virtual machines hosted on a datacenter or network, one or more functions (e.g., function-as-a-service, virtualized function, serverless computing function, etc.) hosted on one or more execution environments or hosts on a datacenter or network, a distributed physical and/or virtualized infrastructure, etc.

In some cases, the supply chain management system 100 can be implemented in a distributed fashion across one or more networks and/or devices. For example, the supply chain management system 100 can be a distributed system implemented by or hosted on, one or more hosts and/or infrastructure nodes/components/systems on one or more clouds, datacenters, networks, and/or compute environments.

In some implementations, the storage 108, the compute components 110, the processing engine 120, the AI/ML engine 122, the document management system 124, and/or the presentation engine 126 can be part of the same computing device. For example, in some cases, the storage 108, the compute components 110, the processing engine 120, the AI/ML engine 122, the document management system 124, and/or the presentation engine 126 can be implemented by a server computer. In other implementations, the storage 108, the compute components 110, the processing engine 120, the AI/ML engine 122, the document management system 124, and/or the presentation engine 126 can be part of two or more separate computing devices.

The storage 108 can be any storage device(s) for storing data, such as shipment data, invoices, tracking and/or visibility information (e.g., shipment routes, shipment states, driving/transportation information (e.g., tracking, estimates, options, rates, updates, etc.), historical information, reports, shipment statistics, information collected from one or more sources, statistics, documents/files, data objects, profiles, carrier information, shipper information, industry information, load or freight information, requirements or constraints, preferences, analytics, collaboration data (e.g., messages, comments, documents, etc.), reports, and/or any other data. Moreover, the storage 108 can store data from any of the components of the supply chain management system 100. For example, the storage 108 can store data (e.g., shipment data, invoices, processing parameters, predictive outputs, processing results, generated estimates, algorithms, tracking data, analytics, messages, reports, etc.) from the compute components 110, the processing engine 120, and/or the AI/ML engine 122, data or content from the document management system 124 (e.g., documents, data objects, etc.), and/or data or content from the presentation engine 126 (e.g., renderings, display outputs, interface content, web page content, message content, etc.).

In some implementations, the compute components 110 can include a central processing unit (CPU) 112, a graphics processing unit (GPU) 114, a digital signal processor (DSP) 116, an application-specific integrated controller (ASIC) 118, and/or one or more other processing devices or controllers. It should be noted that the compute components 110 shown in FIG. 1 are provided for illustration purposes and, in other examples, the supply chain management system 100 can include more or less (and/or different) compute components than those shown in FIG. 1.

The compute components 110 can perform various operations such machine learning and/or AI operations, optical character recognition, data extraction, data validation, document management, shipment generation (e.g., generation of shipment records, orders, and/or associated data), predictive estimates or calculations, graphics rendering, content delivery, data processing, object or feature recognition, image processing, data mining, tracking, filtering, mapping operations, messaging operations, content generation, shipment analytics, workflow management, and/or any of the various operations described herein. In some examples, the compute components 110 can implement the processing engine 120, the AI/ML engine 122, the document management system 124, and/or the presentation engine 126. In other examples, the compute components 110 can additionally or alternatively implement one or more other processing engines and/or software services.

The operations performed by the processing engine 120, the AI/ML engine 122, the document management system 124, and/or the presentation engine 126 can be implemented by one or more of the compute components 110. In one illustrative example, the processing engine 120, the one or more AI/ML engine 122, and/or the document management system 124 (and associated operations) can be implemented by the CPU 112, the DSP 116, the ASIC 118, and/or a neural processing unit (NPU) 119, and the presentation engine 126 (and associated operations) can be implemented by the CPU 112 and/or the GPU 114. In some cases, the compute components 110 can include other electronic circuits or hardware, computer software, firmware, or any combination thereof, to perform any of the various operations described herein.

In some cases, the compute components 110 can generate and/or provide a user interface (UI) or content item for presenting/displaying/rendering data such as shipment data, tracking and/or visibility information (e.g., real-time and/or predicted tracking and/or visibility information) associated with shipments and/or freights/loads, shipment analytics/insights, booking data, documents, statistics, messages, previews, visualizations, maps, navigation data, routes, etc. In some examples, tracking and/or visibility information can include, for example, and without limitation, real-time and/or estimated/predicted shipment states/status and/or statistics, real-time and/or estimated/predicted routes and/or ports, shipment analytics/insights, schedule data, terminal data, shipment conditions, shipment parameters, shipment updates, tracking visualizations, notifications, etc. In some examples, the UI can present real-time visibility information obtained at one or more periods/stages during the journey. In some examples, the compute components 110 can provide such UI and/or information via the presentation engine 126.

In some examples, the compute components 110 can extract data from invoices and automatically generate shipments based on the invoice data and tracking/visibility information associated with the shipments. For example, in some cases, the processing engine 120 and/or the AI/ML engine 122 implemented by the compute components 110 can extract data from invoices and automatically generate shipments based on the invoice data and tracking/visibility information associated with the shipments.

In some examples, the processing engine 120 implemented by the compute components 110 can predict, in prior, the route a freight or load is going to travel from a pickup location to a delivery destination and/or the location of the freight or load at one or more times, based information obtained or collected by the processing engine 120, such as any shipment data, load information including one or more attributes of the load and/or trip, carrier data, supplier data, routing data, port data, etc. The attributes of the load and/or trip may include, for example, the carrier transporting the load, the industry to which the item being carried can be categorized to, the shipper of the load, the day/time at which the load is being carried, delivery preferences and/or constraints, load characteristics and/or requirements, the distance between the pickup location and the delivery destination, the geographic region(s) associated with the trip, seasonality characteristics (e.g., a season associated with the trip), port information, etc.

In some examples, the processing engine 120 may analyze a history of previous loads from the particular shipper to identify additional information, such as information about the carrier often used by that shipper and/or for that type of load (e.g., certain carriers having a temperature-controlled vehicle if the load has temperature requirements, certain carriers having a vehicle that can transport a certain type of chemical included in the load, certain carriers that can transport loads as large as the load being transported, etc.). The processing engine 120 may also review a history of trips by that carrier and/or for similar loads and identify certain route patterns. Based on some or all of this information above (and/or any other relevant information), the processing engine 120 may identify a most-probable route that the carrier with the load will travel and/or a ranked list of possible routes that the carrier of the load will travel. The processing engine 120 can generate a prediction output identifying the predicted route for the load.

In some aspects, the processing engine 120 can generate tracking/visibility information associated with a shipment. In some examples, the processing engine 120 can generate tracking/visibility information based on shipment data generated based on invoice data as previously explained. In some cases, the processing engine 120 can generate the tracking/visibility information based on real-time state information (e.g., location measurements/updates, real-time events information, statistics, real-time reports, predicted/estimated location information, predicted/estimated events, analytics/insights, etc.) and/or predicted/estimated information obtained by the processing engine 120. For example, in some cases, the processing engine 120 can generate updates about the route a load/shipment is traveling (and/or is predicted to travel), actual and/or predicted transportation (e.g., driving, shipping, etc.) patterns, statistics associated with a load/shipment (e.g., stops, ports, lanes, speed, trajectory, shipment/transportation events, delays, departures, arrivals, updates, locations, timing information, rates, geographic events, shipment/transportation conditions, etc.), schedules, movements, progress data, timing estimates, etc.

Moreover, the processing engine 120 can generate such information and operate in scenarios where there is no real/actual or accurate visibility information or there is only partial real/actual or accurate visibility information. For example, the processing engine 120 can generate such information and operate in scenarios where there are only limited real-time data updates (e.g., only at limited times and/or locations during the trip) about the carrier or load available. Real/actual visibility information can be obtained from one or more sources such as, for example, one or more GPS devices, ELD devices, a shipper/carrier/third party (e.g., location updates from the shipper, carrier, or a third party), the Internet, electronic devices (e.g., smartphones, tracking devices, laptops, tablet computers, servers, etc.), device pings, data web scrapping, API endpoints, news reports, users, computers on vehicles, smart devices, and/or any other sources.

In some examples, the processing engine 120 can implement the AI/ML engine 122 to extract data from printed invoices and/or invoice documents to generate a shipment and/or tracking/visibility information. In some cases, the processing engine 120 can implement the AI/ML engine 122 to predict/estimate shipment information such as, for example, the route a shipment is going to travel from a pickup location to a delivery destination, estimated time of arrivals, estimated time of departures from locations (e.g., stops, ports, intermediate destinations, etc.) along a route/path of a shipment, estimated delays, estimated rates, estimated transit times, estimated transit conditions, estimated shipment changes, estimated shipment performance, etc. In some cases, the AI/ML engine 122 can implement one or more neural networks, such as a convolutional neural network (CNN), a recurrent neural network, a classifier, etc., to generate predictions/estimates and/or extract data from invoice documents and/or images. In other cases, the AI/ML engine 122 can implement other techniques, algorithms, etc., to generate predictions/estimates such as, for example, sequence modeling, learning, prediction (e.g., using AI), Markov chains, tensor factorization, dynamic Bayesian networks, conditional random fields, etc.

The document management system 124 can manage documents and data associated with shipments, invoices, terms, requirements, carriers, suppliers, goods/loads, shippers, workflows, templates, documentation, purchase orders, instructions, customs documents, shipment documents, schedules, etc. In some examples, the document management system 124 can support one or more collaboration features such as, for example, messaging, document sharing, templates, commenting, interactions, versioning/synchronization, etc. In some cases, the document management system 124 can help shippers manage complex and/or copious documentation requirements of international (and other) shipping, and collaborate with parties involved in a booking/shipment. In some examples, the document management system 124 can provide real-time messaging tools organized around shipments and/or workflows (in addition to or in lieu of emails, manual processes, etc.), automated templates, triggers of tasks, permissions, documentation (e.g., invoices, purchase orders, bills of landing, courier instructions, packing lists, etc.), etc.

The presentation engine 126 can generate/render information for presentation on a display device. For example, the presentation engine 126 can display/render shipment information, tracking/visibility information, documents, statistics, maps and/or mapping information, navigation information, statistics, previews, visualizations, animations, metrics, updates, reports, etc. In some examples, the presentation engine 126 can display actual and/or predicted routes, stops, delays, events, statistics, and/or other information associated with a shipment. In some cases, the presentation engine 126 can display a map with actual and/or predicted/preview routes, stops, delays, events, statistics, etc. In some cases, the processing engine 120 and/or the AI/ML engine 122 can generate route previews and/or visibility information in maps based on data and calculations generated by the processing engine 120 and/or the AI/ML engine 122. The presentation engine 126 can generate a user interface displaying such information. In some cases, the document management system 124 can maintain and/or manage mapping data such as routes, directions, landmarks, locations, geographic information, addresses, distance information, three-dimensional renderings, route previews, landscapes, road/street names, shipping lanes, ports, navigation data, status data, etc.

In some examples, the supply chain management system 100 can provide real-time supply chain visibility and end-to-end management for shipments. The shipments can include transportation by land, transportation by ocean, transportation by air, local/national shipments, and/or international shipments. The supply chain management system 100 can integrate advanced document management capabilities (e.g., via document management system 124), robust collaboration features and support for bookings, end-to-end real-time and/or predictive tracking, etc. The supply chain management system 100 can perform an automated process as described herein, which can, among other things, expedite the flow of goods through busy routes and/or locations such as ports, significantly reduce detention and demurrage costs, improve shipment and/or supply chain visibility, improve system performance/efficiency, improve customer satisfaction, etc.

In some examples, the supply chain management system 100 can provide integration (e.g., via automated processing, via application-programming interfaces, etc.) between various systems and enable data sharing between the supply chain management system 100 and other shipper and/or supply chain systems such as, for example, and without limitation, any transportation management system (TMS), enterprise resource planning (ERP) platform, etc.

In some examples, the supply chain management system 100 can provide a variety of product capabilities such as, for example and without limitation, advanced document management and collaboration features that help shippers manage the complex and copious documentation requirements of shipping (particularly international shipping) and/or collaborate with all parties involved in a container move; real-time messaging tools organized around shipments and workflows (e.g., in addition to or in lieu of emails and/or manual processes); automated templates that can trigger tasks, set permissions, prepare documentations (e.g., shipments, purchase orders, bills of landing, courier instructions, packing lists, among others); collaboration features that enable trading partners to collaborate in a secure network-based or cloud-based digital hub that contains the necessary shipping documents (including international shipping documents); improved/enhanced tracking capabilities which can capture more data via one or more sources and/or with greater accuracy, provided additional visibility, etc.; greater visibility into bookings; end-to-end tracking that links any transportation segments/hops (e.g., ocean, rail, air, road, yard, etc.) such as ocean to rail, air, over-the-road and/or yard; provide deeper insights and analytics with reporting of on-time performance, cycle and transit times, detention and demurrage, among others; etc.

The supply chain management system 100 can source data from one or more sources. For example, the supply chain management system 100 can source data from integrations (e.g., via an automated process as described herein, electronic data interchange (EDI) documents, APIs, etc.) with carriers; real-time automatic identification system (AIS) data through vessel transponders; schedule data across routes, lanes, carriers, services, etc.; terminal data across terminals; dray carrier integrations for multimodal connectivity; booking data; supplier documents and/or systems; etc.

The supply chain management system 100 can provide transparent shipping schedules, tracking, timely documentation, end-to-end and/or real-time visibility, etc., which can reduce or eliminate various problems and/or complexities in shipping and/or supply chain scenarios, such as the complex and vast amount of documentation requirements, rate management, bookings, etc., in shipping including international ocean shipping. The supply chain management system 100 can eliminate or mitigate detention and demurrage risks, deliver a seamless experience to customers, reduce costs, etc.

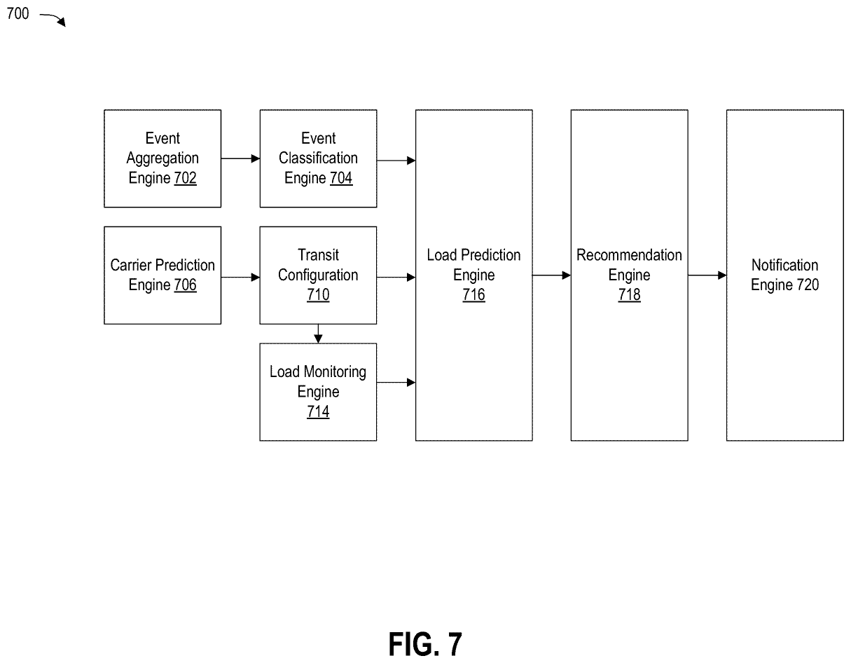

While the supply chain management system 100 is shown to include certain components, one of ordinary skill will appreciate that the supply chain management system 100 can include more or fewer components than those shown in FIG. 1. For example, the supply chain management system 100 can also include, in some instances, one or more memory devices (e.g., RAM, ROM, cache, and/or the like), one or more networking interfaces (e.g., wired and/or wireless communications interfaces and the like), one or more display devices, and/or other hardware or processing devices that are not shown in FIG. 1. An illustrative example of a computing device and hardware components that can be implemented with the supply chain management system 100 is described below with respect to FIG. 7.

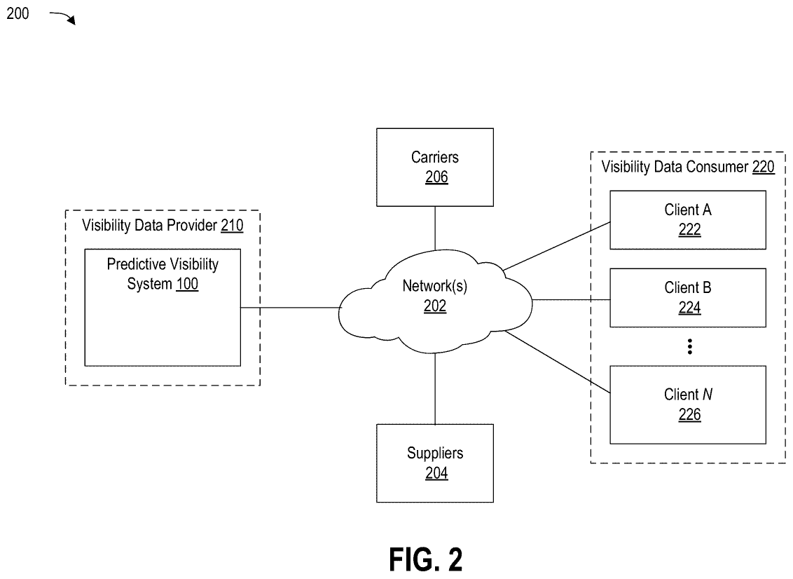

FIG. 2 illustrates an example environment 200 for implementing an integrated shipment platform such as supply chain management system 100. In this example, the environment 200 includes the supply chain management system 100. The supply chain management system 100 can automate the creation of shipments and related data and/or workflows, and provide tracking/visibility information to any client devices 222-226 of shipment data consumers 220. In some examples, a shipment can include a shipment record and/or order in the supply chain management system 100. In some cases, an item associated with a shipment can be shipped via land (e.g., road, rail, yard, etc.), air, water, etc. In some examples, an item associated with a shipment can be shipped within geographic boundaries (e.g., locally, nationally, etc.) and/or across geographic boundaries (e.g., internationally, etc.).

The supply chain management system 100 can communicate with suppliers 204, carriers 206, and the client devices 222-226 over a network 202. The network 202 can include one or more private and/or public networks, such as one or more local area networks (LANs), wide area networks (WANs), cloud networks (private and/or public), on-premises datacenters, cellular networks, virtual private networks (VPNs), and/or any other type(s) of network(s).

The client devices 222-226 can include any electronic devices used by shipment data consumers 220, such as users and/or customers of an entity (e.g., a shipper, a management party, etc.) associated with the supply chain management system 100, to communicate with the supply chain management system 100 and obtain associated data and services, as further described herein. For example, the client devices 222-226 can include a laptop computer, a tablet computer, a smartphone, a desktop computer, a server, an internet-of-thing (IoT) device, a smart or autonomous vehicle (e.g., a computer on an autonomous vehicle), a mobile device, etc. In some examples, the client devices 222-226 can access information and services provided by the supply chain management system 100, such as shipment data and/or tracking/visibility information (e.g., real-time and/or predicted), via the network 202. In some cases, the client devices 222-226 and/or the shipment data consumers 220 can also provide information to the supply chain management system 100. For example, the client devices 222-226 can provide shipment data, documents, inputs, and/or updates to the supply chain management system 100.

The supply chain management system 100 can obtain information from one or more sources such as, for example, suppliers 204 and/or carriers 206, which the supply chain management system 100 can use to create shipments, provide shipment data, provide shipment tracking/visibility information, etc. Such information can include, for example and without limitation, information about a shipment (e.g., a load, a destination, an origin, shipment terms and/or requirements, invoices, booking data, rates, preferences, etc.), information about a load (e.g., load attributes such as the type of load, the weight of the load, load restrictions/constraints; delivery parameters; carrier; shipper; industry; shipment priority; appointment time; etc.), information about a carrier (e.g., carrier identity, carrier history, carrier statistics, carrier preferences, carrier profile, type of transportation vehicle, etc.), information about an industry (e.g., industry profile, industry preferences, industry statistics, industry requirements, industry constraints, etc.), information about a shipper (e.g., shipper identity, shipper history, shipper statistics, shipper preferences, shipper profile, etc.), historical information (e.g., shipping or carrier patterns or histories, load patterns or histories, industry patterns or histories, source and/or destination patterns or histories, router patterns or histories, etc.), mapping data, traffic data, weather data, news information, agency reports, order information, regulations, location information, tracking parameters, notifications, cost information, supply chain information, potential delays or hazards, trip information, sensor data (e.g., GPS data, electronic logging device (ELD) data, image sensor data, acceleration measurements, velocity measurements, elevation measurements, radar data, positioning data, etc.), status updates (e.g., location updates, delay updates, event updates, transportation updates, route/navigation updates, real-time updates, etc.), distance between an origin and destination location, booking data, and/or any other relevant information.

In some examples, the supply chain management system 100 can receive at least some of such information from the suppliers 204 and/or the carriers 206 via the network 202 and/or a separate communication path such as a separate network, a direct connection (wired or wireless) connection, an out-of-band link/connection, and/or any other mechanism or path. In some examples, the supply chain management system 100 can receive one or more portions of such information from the client devices 222-226 and/or the shipment data consumers 220. In some cases, the supply chain management system 100 can obtain one or more portions of such information from one or more other sources (not shown). The one or more other sources can include, for example, the Internet, a news source, a government agency, a sensor or electronic device (e.g., a GPS device, an ELD device, a radar, a navigation system, etc.), a database, a data portal, a data repository, an email system, an API endpoint, a document management system, an ERP system, a TMS, a third party, a port, a vessel, a server, etc.

In some cases, the suppliers 204 and/or the carriers 206 can include one or more systems and/or components configured to communicate with the supply chain management system 100 and/or integrate with (e.g., exchange and/or synchronize data) the supply chain management system 100. For example, the suppliers 204 and/or the carriers 206 can include an ERP system configured to communicate with the supply chain management system 100, a document management system configured to communicate with the supply chain management system 100, an endpoint configured to communicate with the supply chain management system 100, an API configured to communicate with the supply chain management system 100, a server configured to communicate with the supply chain management system 100, a data store (e.g., database, etc.) configured to communicate with the supply chain management system 100, a transportation management system configured to communicate with the supply chain management system 100, a booking system configured to communicate with the supply chain management system 100, a collaboration system configured to communicate with the supply chain management system 100, an email system, a file sharing system, etc.

While the example environment 200 is shown to include certain devices and entities, one of ordinary skill will appreciate that the example environment 200 is only one illustrative example and, in other examples, can include more or fewer devices and/or entities than those shown in FIG. 2.

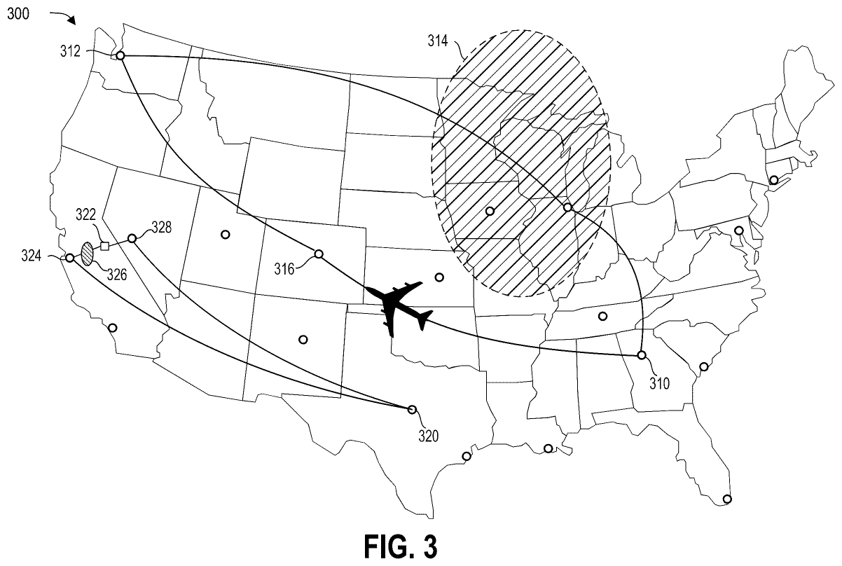

FIG. 3 is a conceptual illustration 300 of a predictive tracking management system, in accordance with some aspects of the disclosure. In some aspects, a predictive tracking management system is configured to identify adverse conditions (e.g., a constraint) that may affect a load and recommend alternative transit recommendations. In one example, an entity may want to ship a load from a first location 310 to a second location 312 using a particular carrier. In this case, the carrier may have a hub that is located in zone 314 that is experiencing weather that may cause a delay. For example, if the load is time sensitive and contains biological materials that can only be maintained in the load for 36 hours, the shipping entity would send the load using a high service level agreement (SLA) to ensure next-day delivery. In this example, the carrier may transport the load to their normal hub within the zone 314, and the load may then be delayed for a variety of reasons. For example, ice conditions overnight may delay arriving and departing air traffic within the zone 314 and could prevent the load from being delivered to the second location 312.

A predictive tracking management system is configured to identify adverse constraints from structured and unstructured content and predict supply chain interference. For example, the predictive tracking management system may determine that the load will be routed through the zone 314 based on the carrier and may provide guidance to the shipper to select a different carrier with a hub in location 316. In some aspects, the predictive tracking management system may also provide real-time updates for load management based on structured and unstructured content. As noted above, carriers only provide limited information such as arrival and departure information, and identification of supply chain delays is opaque and difficult to understand when using only carrier information.

In another example, the predictive tracking management system may also identify adverse conditions based on origin and destination. In one example, location 320 may be an origin for a load and location 328 may be the corresponding destination for the load. In some cases, location 320 may be the destination and location 328 may be the origin. In some aspects, the predictive tracking management system may identify a carrier based on the adverse constraints, such as an environmental hazard 326 (e.g., a fire), and may inform a shipment system or other party of delays that may be incurred due to the environmental hazard 326. For example, if the load is being sent from location 320 to location 322, the predictive tracking management system may determine that shipments sent to location 324 would be delayed due to the environmental hazard 326 but shipments sent to location 328 may be delivered on time.

In another example, the shipper sending a load from location 322 may determine that collections will not be made based on carriers shipping through location 324 and a delivery will be unable to be made within a desired time period. For example, if the shipper wants to send the load overnight, shipping the load through location 324 would not occur due to the environmental hazard 326. In some cases, the predictive tracking management system may inform the user that moving the origin of the shipment to location 328 would arrive in the correct time period. In some cases, the predictive tracking management system may modify the transit configuration to ensure that the shipment is received in time. In some cases, a shipper may be able to dynamically route loads based on automation and the predictive tracking management system may upgrade an SLA (e.g., from 2-night to overnight) before the load arrives in the shipment hub. The load may be diverted in real-time based on upgrading the service.

In some aspects, the predictive tracking management system is configured to provide information to the shippers to inform of load delivery options, track loads, and provide remedies for the shippers. The predictive tracking management system may aggregate disparate information from carriers, public sources, and other services to identify intrinsic constraints and extrinsic constraints that may affect the load shipment. Intrinsic constraints are conditions and limitations that are associated with the carrier, such as a maximum capacity of an airplane. Extrinsic constraints are conditions and limitations that are outside of the carrier's control, such as weather, events, air traffic delays, and so forth.

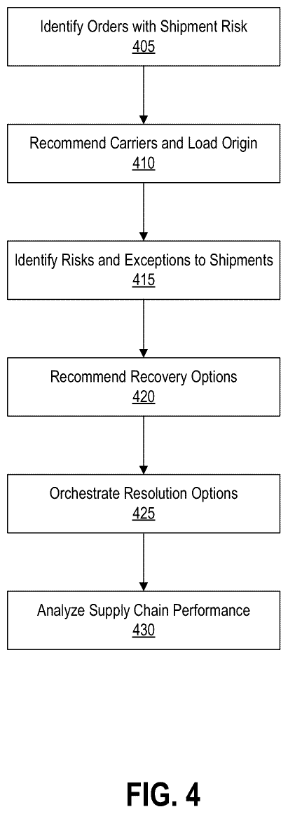

FIG. 4 is a flow diagram of a method 400 for tracking shipments using a predictive tracking management system, in accordance with some aspects of the disclosure.

At block 405, the predictive tracking management system may identify orders with an acceptable or unacceptable risk of shipment delay. For example, orders that have an intolerable amount of risk are identified. The intolerable risk may be based on the contents of the load and value. For example, shipping biological materials with a 50% probability of a delay may be unacceptable, but shipping goods with a 50% risk of delay may be acceptable. In some aspects, the predictive tracking management system considers real-time information related to the various factors to determine whether a carrier can satisfy the shipment requirements (e.g., a required delivery date and time).

At block 410, the predictive tracking management system may recommend transit reconfiguration based on a transit configuration. Non-limiting examples of transit configuration include the selection of carriers, load origin, load destination, a route, and service level (e.g., shipment duration, shipment parameters). In some cases, the transit configuration can also include price limitations or value per risk percentage. At block 410, the shipper selects a carrier for collecting (or receiving) and delivering the load to a destination.

At block 415, after the consignment of the load to the carrier, the predictive tracking management system may identify risks and exceptions to shipments based on a combination of predictive analytics and identification of issues within the carrier. For example, the predictive tracking management system may connect to an API of the carrier shipping service and identify whether the load will be timely or delayed. For example, the predictive tracking management system may identify adverse conditions based on weather, emergencies, traffic, and so forth. The predictive tracking management system may be configured to provide notifications to a client system when an unacceptable risk for the load, which is consigned to the carrier, is identified. Non-limiting examples of a client system include a manufacturing execution system (MES), a TMS, a warehouse management system (WMS), an ERP system, a bespoke system, and so forth. In some aspects, the predictive tracking management system may be integrated into the client system to monitor information and receive information from the client system to engage carrier shipping services, freight shipping services, and so forth. In other examples, the predictive tracking management system may be an external system that the client connects with for sending and receiving information. For example, the predictive tracking management system may be configured as a service for the client system to connect with and share information.

At block 420, the predictive tracking management system may be configured to identify recovery and/or remediation options that are external to the carrier shipping service. In some aspects, the predictive tracking management system is configured to include a combination of ML operations and rule-based operations. The predictive tracking management system may identify options to recover the load, redirect the load, redirect another load that is en route to another destination, and other potential options. For example, the predictive tracking management system may interface with a client system (e.g., a TMS, a WMS, etc.) to identify potential resolutions. For example, a load delayed in ground service with a high monetary impact may be supplemented with a separate load that satisfies all or part of the delayed load.

In some cases, the carrier shipping service may allow modification of the service level during transit. The predictive tracking management system is configured to provide an interface to enable the customer to resolve the delay based on various options. In other aspects, the predictive tracking management system may redirect the flow of the load, either within the carrier shipping service or by another mechanism such as an intermediary delivery. In another aspect, the carrier shipping service may enable an agent of the shipper to intercept the load at the carrier's facility to ensure that the load arrives at a destination by a specific time. For example, if a load is inadvertently delayed a day and the load is guaranteed for the next day at 2:00 PM, but the load is needed for a meeting at 9:00 AM, a customer may elect to escalate delivery by engaging an agent to intercept the load at the carrier's facility and deliver it to the destination before the meeting.

At block 425, the predictive tracking management system may be configured to orchestrate resolution options to resolve any issues. In some cases, the predictive tracking management system can be configured to orchestrate an external system, enterprise system, or third party companies or system, such as a WMS or MES to identify potential resolutions. In one aspect, the predictive tracking management system may be configured to execute a workflow engine to manage execution of various recommendation systems associated with different parties. A customer can be provided various tradeoffs associated with the various resolution options identified based on joint operation of the predictive tracking management system and associated recommendations systems. For example, the MES may identify a partial resolution of delayed goods by prioritizing manufacturing of a particular component, which can then be expedited and shipped in lieu of the delayed load.

At block 430, the predictive tracking management system is configured to analyze supply chain performance based on various metrics and data. In one aspect, the predictive tracking management system may be configured to identify performance metrics associated with different carrier shipping services based on different metrics including lane (e.g., an origin to a destination), service, customer, and so forth. The metrics may also be converted into time series data and analysis over a period of time can be performed. For example, the predictive tracking management system may identify the trends over time, or trends at an interval (e.g., a service between two locations is poor on a specific day of the week or month), and so forth. In some aspects, the predictive tracking management system may identify On-time, In Full (OTIF) metrics, fulfillment lead times, etc. trending in relation to defined targets. OTIF metrics are a performance indicator for measuring how many orders were delivered on time and in full. In some aspects, when a metric is lagging, the predictive tracking management system may be configured to link causes of delay and address a root cause of the delay. For example, shipments on Thursday may have a higher chance of being delayed, which causes goods or materials to be unavailable. In some cases, the predictive tracking management system uses an ML model to identify the root causes based on a variety of unstructured data. In some aspects, the various recommendations may be tracked through a workflow engine for supervising various predictive tracking management system tasks. The predictive tracking management system is also configured to store data retrieved or generated for additional training of an ML model.

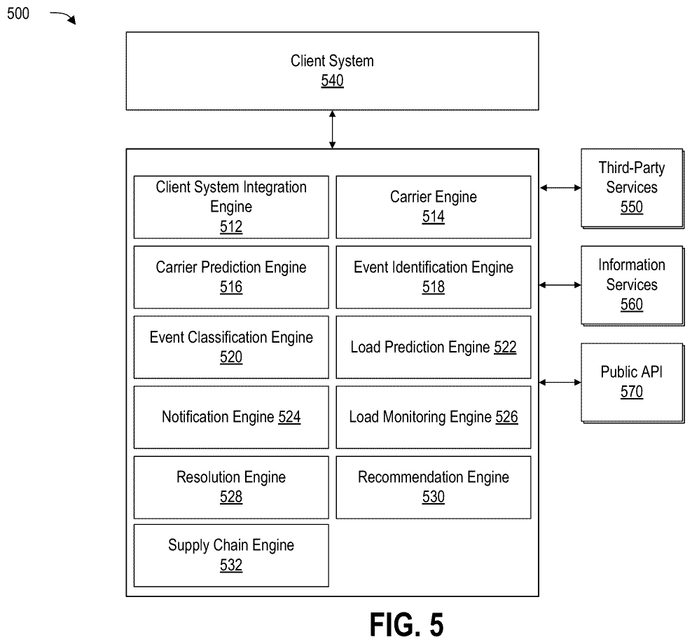

FIG. 5 is a block diagram illustrating an architecture of a predictive tracking management system 500, in accordance with some examples. In some aspects, the predictive tracking management system 500 is configured to integrate with a client system 540 and uses various third-party services 550, information services 560, and public APIs 570 to predict load delivery issues and exceptions. In one illustrative example, the client system 540 can be various systems such as an ERP, WMS, TMS, and so forth, and can be integrated with the predictive tracking management system 500 to facilitate carrier selection and carrier monitoring.

In some aspects, the predictive tracking management system 500 can include a client system integration engine 512, a carrier engine 514, a carrier prediction engine 516, an event identification engine 518, an event classification engine 520, a load prediction engine 522, a notification engine 524, a load monitoring engine 526, a resolution engine 528, a recommendation engine 530, and a supply chain engine 532. In some aspects, the client system integration engine 512 is configured to expose functionality and data to the client system 540 and to expose the functionality of the client system 540 to the predictive tracking management system 500. For example, the predictive tracking management system 500 may expose a microservice using a remote procedure call (RPC) or a representational state transfer (REST) API to allow various types of communication between the predictive tracking management system 500 and the client system 540. In some cases, the predictive tracking management system 500 may be an on-premises solution (e.g., a containerized application) or an off-premises solution available to customers.

The carrier engine 514 is configured to integrate with systems of various carrier shipping services and extract information related to one or more loads. For example, the carrier engine 514 may use a public API or a private API or interface to interface with a carrier shipping service. The carrier engine 514 may also store rules and various data related to the service (e.g., hub identifications, retail locations, etc.). The carrier prediction engine 516 is configured to use various information as described herein to identify a transit configuration, or a lane, from the origin to the destination. In some cases, the carrier prediction engine 516 determines methods of shipment, identification of locations of shipment, and other information such as the identity of a last mile carrier, and so forth.

The event identification engine 518 is configured to identify events that may be pertinent to the predictive tracking management system 500. For example, the event identification engine 518 may be configured to extract structured data from third-party services 550. Non-limiting examples of third-party services include commercial weather services, commercial traffic prediction services, generational chat services (e.g., ChatGPT), ML-based classification services, and so forth. The event identification engine 518 may also connect to various information services, such as a syndication stream or a website, and gather targeted information that can be used by the predictive tracking management system 500. For example, the event classification engine 520 may use the various information provided by the event identification engine 518 and classify different types of events. Examples of classifications include weather classifications (e.g., sunny, rainy, etc.), event classification, traffic classifications, interference classifications (e.g., construction, etc.), and so forth. In some cases, the event identification engine 518 can also connect to various information services, such as a news service or a weather service, to monitor for alerts and other pertinent information that may affect shipment. The event identification engine 518 can also receive information from the public API. For example, the public API can be a weather service or an API associated with the carrier shipping service and receive structured data. In some cases, the public API can be a propriety service using a large language model (LLM) such as a generative pre-trained transformer (GPT) that is trained to summarize, extract, or process information.

The load prediction engine 522 may be configured to use the classified data, rules, and routes from the carrier engine 514, and carrier predictions from the carrier prediction engine 516 to predict various aspects of the shipment. In one illustrative example, the load prediction engine 522 may identify a likelihood of delay associated with that route based on the various events and information collected by the predictive tracking management system 500. For example, the load prediction engine 522 may receive weather information related to a particular geography and determine whether there may be delays based on the weather and the location of the delays. For example, the carrier prediction engine 516 may identify routes with an altitude over 4000 feet and including a section of road with more than a 10-degree grade have an 80% chance of experiencing a weather-induced delay. Using objective data, the load prediction engine 522 can identify a risk and a confidence associated with that risk based on extrinsic and intrinsic factors.

In some cases, the notification engine 524 is configured to send automated messages or alerts to users based on predefined triggers or events, such as when a load's risk for delay increases to an unacceptable threshold. The notification engine 524 may also identify a destination or a route change during and before consignment, which can affect the delay probability and the confidence. In some cases, the notification engine 524 can also be executed prior to shipment, such as when a load is unshipped and events change the delay probability, either for better or worse.

The load monitoring engine 526 is configured to monitor a load from consignment to delivery. In some cases, the load monitoring engine 526 may receive a notification from the carrier shipping service (e.g., a text message indicating a load was received) and update progress of the load, as well as compare shipment progress with expected progress. The load monitoring engine 526 may also invoke the notification engine 524 to identify any changes to the delay probability.

In the event that the notification engine 524 identifies that the risk changes, the load monitoring engine 526 may trigger the execution of the resolution engine 528 to identify possible resolutions to the potential delay. In some aspects, the resolution engine 528 can be integrated into the client system 540 and can be configured to identify alternative resolutions, such as diverting resources from one location to the intended recipient of the delayed load. In some cases, the resolution engine 528 may be able to resolve changes to the transit configuration by changing service level, intercepting the load with an agent, changing delivery location, and so forth.

The recommendation engine 530 may be configured to identify recommendations that partially or wholly satisfy the delay, such as rerouting a load in transit. In other cases, the recommendation engine 530 may identify merchandise or other materials that may be received in time, such as diverting another load, prioritizing production of goods that may substitute for the delayed load, and so forth. The recommendation may provide options to the customer identifying possible resolutions, delays, disruptions, and so forth to enable an informed party the option to select the best resolution.

The supply chain engine 532 is configured to identify carrier-to-carrier performance based on service level and several other properties, such as by lane, customer, transit, and so forth. The supply chain engine 532 may be configured to convert data into a time-series representation and allow complex visuals to be presented to identify trends and patterns, which can be used by the supply chain engine 532 to identify the root cause of the problem. For example, delays incurred on a Friday may be because of traffic at a specific location, and the delays may be resolved based on rerouting carriers. In some cases, the recommendations can be coupled with a workflow engine to allow customers to identify root causes and ML recommendations for resolving issues.

In some aspects, the delay probability is a complex calculation and requires significant resources based on the aggregation of information, and is something possible using a combination of rules and ML techniques. Even with all aggregated information, a person is unable to perform the tasks executed by the predictive tracking management system 500 with any precision and within a reasonable period of time. In particular, because predictive tracking management system 500 monitors the packages and identifies risks autonomously based on aggregated and disparate information, its techniques could not reasonably be performed by a person.

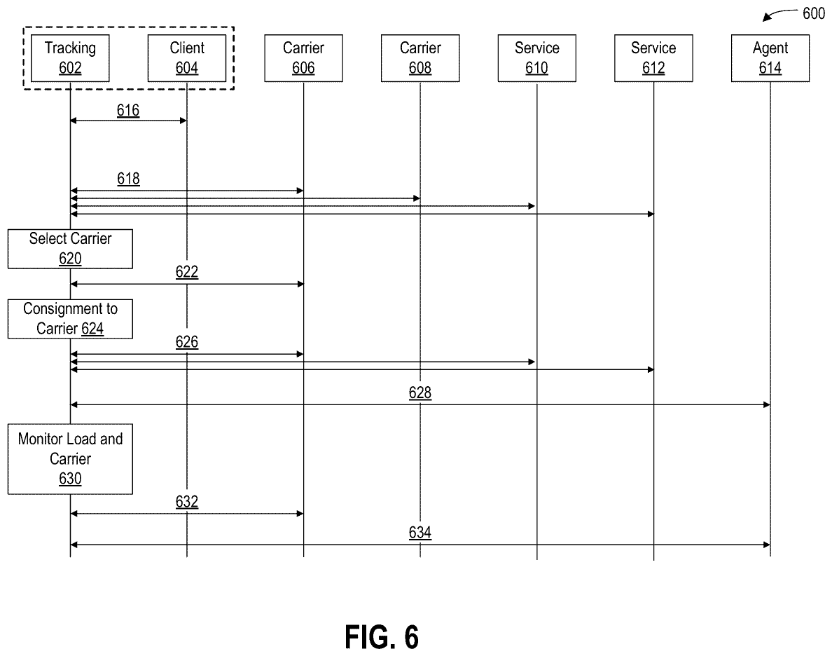

FIG. 6 is a sequence diagram 600 illustrating operation of a predictive tracking management system in accordance with some aspects of the disclosure. A tracking system 602 may be configured to integrate with a client system 604, either through an on-premises configuration or through a public or private network. In some aspects, the tracking system 602 is configured to connect with a first carrier 606, a second carrier 608, a first service 610, and a second service 612, and may provide notifications to an agent 614. In some aspects, the first service 610 and the second service 612 are third-party external services and can provide information pertinent to shipment. For example, the first service 610 can be a weather service, and the second service 612 can be an air traffic service that provides information that would indicate a flight may be delayed.

At reference numeral 616, the tracking system 602 is configured to receive information related to a shipment. In some cases, the tracking system 602 may receive information from the client system 604 based on an order or other information provided by a party. For example, the client system 604 can receive an order for goods and provide information related to the shipment. The information related to the shipment may include various information such as load size, weight, transit information, etc. The tracking system 602 is configured to request information at reference numeral 618 related to a shipment by requesting information from the first carrier 606, the second carrier 608, the first service 610, and the second service 612. In some cases, the first carrier 606 and the second carrier 608 can provide general guarantees based on different service levels. In some cases, the first carrier 606 and the second carrier 608 can provide an improved service level based on the shipment origin or the shipment destination. The first service 610 and the second service 612 may provide information related to the various routes and other pertinent information related to the route, origin, and destination.

Based on the data retrieved at reference numeral 618, the tracking system 602 is configured to select a carrier at block 620. In this case, the tracking system 602 selects the first carrier 606 and requests a shipment at reference numeral 622. The first carrier 606 responds back with pertinent information of the pickup and consignment to the first carrier 606. In some aspects, the tracking system 602 is configured to monitor the route selected based on the first carrier 606 to identify risks of delay.

At block 624, the carrier consigns the load, either by pickup or delivery, and begins transit of the load to the destination. After consignment, at reference numeral 626, the tracking system 602 is configured to connect o the first carrier 606, the first service 610, and the second service 612 to monitor the load. For example, the first carrier 606 provides direct tracking information, such as arrival at a carrier's facility, departure to an intermediary hub, etc. The tracking system 602 may be configured to use this information to revise the prediction. For example, the tracking system 602 may have initially predicted that the route of the load will be through a first carrier hub that is located in the Midwest. However, the first carrier 606 may route the load through a different carrier hub in the southwest for various reasons. In this case, the tracking system 602 may recompute the delay probability based on a revised route of the first carrier 606 and provide a notification to the agent 614 at reference numeral 628. To this end, the tracking system 602 enables the agent 614 of the customer to monitor the consigned load based on events and enables the agent 614 to be aware of the load's location within the carrier shipping service.

At block 630, the tracking system 602 continues to monitor the load based on the information provided by the first carrier 606, the first service 610, and the second service 612. In one illustrative example, the tracking system 602 may detect a delay due to extrinsic conditions, such as weather. In another case, the tracking system 602 may detect a delay due to an intrinsic condition, such as a cargo plane's capacity has been exceeded and a pallet containing the consigned load was not loaded for transit. In some cases, the tracking system 602 may infer the delay based on failing to scan a load for transit between origin and destination. In this case, the tracking system 602 may determine that the likelihood is increased and may seek to identify possible resolutions to the potential delay. As an example, the tracking system 602 may attempt to resolve the delay or update the prediction based on communication with the first carrier 606 at reference numeral 632. In some cases, the tracking system 602 may also provide a notification 634 to the agent 614 that the delay probability has increased due to various conditions.

In any case, the tracking system 602 is configured to proactively monitor the consigned load and provide visibility to the agent 614 and enable the agent to take various actions to remedy the potential delay.

FIG. 7 is a block diagram illustrating a conceptual processing pipeline implemented by a predictive tracking management system, in accordance with some aspects of the disclosure.

In some aspects, an event aggregation engine 702 (e.g., the event identification engine 518) may receive and aggregate various events. In some cases, the event aggregation engine 702 may monitor a combination of general sources, such as weather, with a combination of specific locations based on current and future routes associated with loads. The events are aggregated and provided to an event classification engine 704 to classify the events and provide information based on the classifications.

A carrier prediction engine 706 (e.g., the carrier prediction engine 516) is configured to predict the routes of future and current loads and provide transit configurations 710 for future and current shipments. The transit configuration 710 is provided to a load monitoring engine 714, which periodically monitors the progress of the load based on information received from the carrier as described above.

The event classification engine 704 provides the classifications of the events to the load prediction engine 716 and the carrier prediction engine 706 also provides the transit configuration to the load prediction engine 716. In some cases, the load prediction engine 716 can receive information from the load monitoring engine 714 that identifies the current known information related to the load. The load prediction engine 716 is trained to use identify factors that may cause delay to the load and output various information, such as a delay probability and a confidence of the delay probability to a recommendation engine 718. The recommendation identifies potential resolutions that can be addressed through the carrier, such as escalating a service level or attempting to request the carrier to reroute the load. In some cases, the recommendation engine 718 can also recommend modification of the shipment by the customer. For example, the recommendation engine 718 may predict that a lower service level may have a higher chance of arrival if shipped a day before. The recommendation engine 718 may also recommend options to the customer in the event that the load cannot be delivered in the requested timeframe. For example, the recommendation engine 718 may recommend changing an origin of the shipment to another location based on various factors.

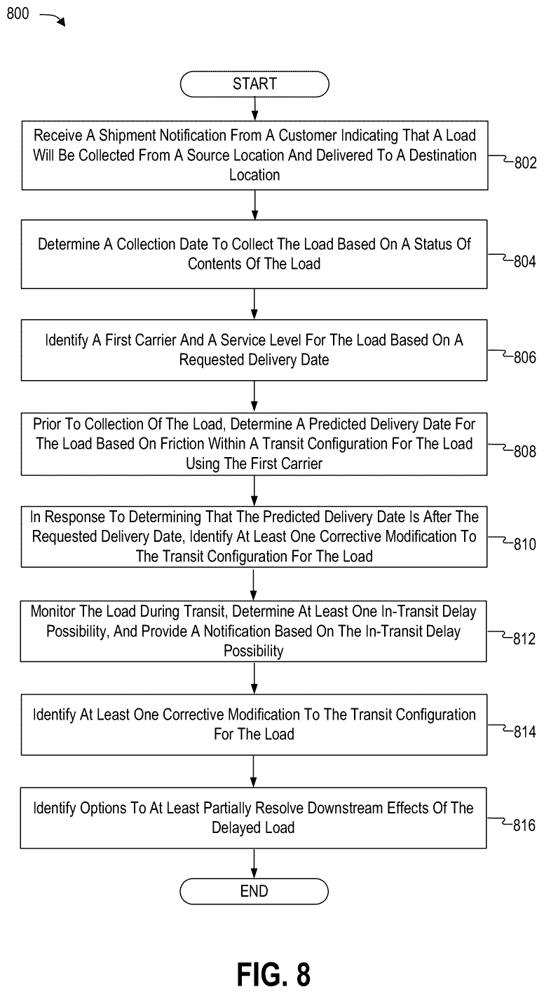

FIG. 8 illustrates an example method 800 of a predictive tracking management system. The method 800 can be performed by a computing device having network communication capabilities and may be configured as a service separate from a client system, or may be integrated into the client system. For instance, the computing system 900 may be configured to perform all or part of the method 800.

Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence.

At block 802, the computing system may receive a shipment notification from a customer indicating that a load will be collected from a source location and delivered to a destination location. In some aspects, the computing system may be integrated into a client system (e.g., an ERP) or may be a separate service.

At block 804, the computing system may determine a collection date to collect the load based on a status of contents of the load. For example, the computing system can monitor the client system to identify a collection date of the load. In one non-limiting example, the client system may be a MES that identifies when then the load will be ready for consignment.

At block 806, the computing system may identify a first carrier and a service level for the load based on a requested delivery date. For example, the computing system may use predictions related to a carrier's service to the destination location to identify a preferred carrier. For example, each carrier may offer a transit method to the destination location, but each carrier has different infrastructure and delivery rates will vary based on the service level, various extrinsic conditions, and so forth. The computing system can utilize the predictions described herein to identify a preferred carrier. In some cases, the computing system can provide a prediction for one or more carriers and allow the customer to select the carrier.

At block 808, the computing system may, prior to collection of the load, determine a predicted delivery date for the load based on friction within a transit configuration for the load using the first carrier. The transit configuration includes at least one of a service level, the source location, the destination location, a route, at least one option related to a portion of the route from the source location to the destination location. The friction within the transit system is associated with at least one intrinsic constraint of the first carrier and/or at least one extrinsic constraint. The intrinsic constraint may be related to capacity within the carrier or aspects that the carrier can control. For example, if the carrier is exceeding a processing capability at hub, the carrier may not be able to process the load (e.g., load) in sufficient time. Further examples of identification of friction and methods of identification of friction follow.

As part of determining the predicted delivery date, the computing system may identify a route and transit method to the destination based on properties of the load, the service level, and the origin. Non-limiting examples of a transit method include air transit, rail transit, sea transit, and automotive transit. The computing system may determine a delay probability of the load based on at least one of intrinsic constraints or extrinsic constraint, and the transit configuration (e.g., a transit method, a route to the destination, etc.).

In one example, the computing system may identify services for determining the delay probability and process the information from the services to determine a delay probability. In some aspects, the services may vary for each load. An example of a first service is a commercial weather service that predicts impacts on supply chain and other logistics that may affect package delivery. The computing system may retrieve the extrinsic constraints from the first service, which may be unstructured (e.g., raw text) or structured (e.g., a response from an API). As described above, the information from the services is obtained before the consignment of the load to provide an accurate reflection of the delay probability before shipment. However, the determination of the delay probability continues after the consignment to the shipping party. In some cases, the information from the various services can be combined in a serial or parallel fashion, or the information from the services can be provided into an ML model that identifies issues based on a wholistic view of the information.

In one example, the computing system may retrieve the intrinsic constraints based on a public interface of the first carrier and obtain a delay probability of the load based on intrinsic constraints associated with the first carrier and the transit method. For example, the computing system may determine that a designated carrier hub is at maximum throughput capacity and the package is at risk of being delayed.

In another example, the computing system may determine a modification probability of a transit reconfiguration during transit based on intrinsic constraints or extrinsic constraints. In some cases, the ML model may identify patterns that can be correlated with a reassignment of the transit configuration. For example, if a particular hub is beyond its capacity or an adverse weather condition may delay packages, the carrier may shift the routes to avoid the adverse constraints at that particular hub. In some cases, the modification can benefit the shipper and prevent a delay, and in other cases, the delay risk may increase. The computing system can identify a modification risk of the package, and further predict downstream effects, such as the delay risk and confidence associated with the identified modification of the transit configuration.

At block 810, the computing system may, in response to determining that the predicted delivery date is after the requested delivery date, identify at least one corrective modification to the transit configuration for the load. The at least one corrective modification to the transit configuration comprises selection of a second carrier, a different service level, and different source location. For example, the computing system may output a user interface to a customer that identifies different transit configurations (e.g., a different carrier, or a different service level) that would satisfy the requested delivery date.

Non-limiting examples of corrective modifications include identifying an alternate origin for the load based on the first carrier, identifying a different carrier for the load, identifying a different service level for the load, identifying an alternate destination for the load, identifying a service associated with the first carrier, and identifying an accelerated collection date; or identifying an alternative package configuration. In some cases, the corrective modifications can accelerate production of goods or prioritize a shipment based on the delay probability.

At block 812, the computing system may monitor the load during transit, determine at least one in-transit delay possibility, and provide a notification based on the in-transit delay possibility. In one aspect, after consignment to the first carrier, monitor transit of the load based on the first carrier. For example, the computing system can connect to the first carrier's public or private infrastructure to track progress of the package. The computing system can continue to monitor intrinsic and extrinsic constraints, such as weather, that could affect delivery and may obtain an in-transit delay probability based on monitoring the transit of the load. To the extent that the in-transit delay probability changes and is different from the delay, the computing system may provide a notification based on the delay probability changing. For example, the computing system may alert the client system or a party responsible for the load.

At block 814, the computing system may identify at least one corrective modification to the transit configuration for the load. For example, the carrier may allow modification of the load while in transit, and the computing system may identify corrective actions (e.g., escalate the service level) to minimize the delay probability. The computing system may display a user interface or provide a communication to a customer to enable the customer to select the corrective action. Based on the customer's input, the computing system can coordinate the corrective action with the carrier.

At block 816, the computing system may identify options to partially resolve the downstream effects of the delayed load. For example, the computing system may integrate with a WMS or MES to identify potential options to address the delayed package. The computing system may also determine further downstream effects associated with options to enable the customer to prioritize a customer.

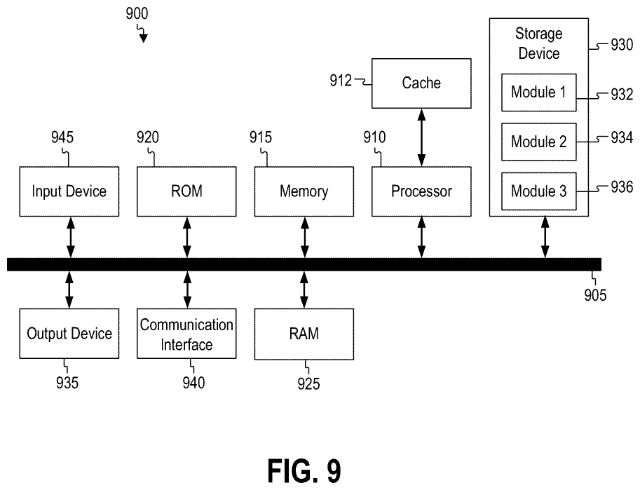

FIG. 9 is a diagram illustrating an example of a system for implementing certain aspects of the present technology. In particular, FIG. 9 illustrates an example of computing system 900, which can be for example any computing device making up an internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 900 includes at least one processing unit (CPU or processor) 910 and connection 905 that couples various system components including system memory 915, such as ROM 920 and RAM 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), crasable programmable read-only memory (EPROM), electrically crasable programmable read-only memory (EEPROM), flash EPROM (FLASHEPROM), cache memory (L1/L2/L3/L4/L5/L #), resistive random-access memory (RRAM/RcRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices, or other small form factor personal computers, personal digital assistants, rackmount devices, standalone devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method, comprising:
receiving a pre-shipment notification from a customer indicating that a load will be collected from a source location and delivered to a destination location;
determining a collection date to collect the load based on a status of contents of the load;
identifying a first carrier and a service level for the load based on a requested delivery date;
prior to collection of the load, determining a predicted delivery date for the load considering friction within a transit configuration for the load using the first carrier, wherein the friction is associated with at least one intrinsic constraint of the first carrier or at least one extrinsic constraint; and
in response to determining that the predicted delivery date is after the requested delivery date, identifying at least one corrective modification to the transit configuration for the load.

2. The method of claim 1, wherein determining the predicted delivery date comprises:
identifying a route and a transit method of the transit configuration based on properties of the load, the first carrier, the service level, the source location, and the destination location; and
determining a likelihood of a delay to the load based on at least one of intrinsic constraints or extrinsic constraints associated with the transit configuration.

3. The method of claim 2, further comprising:
identifying a first service related to a first extrinsic constraint corresponding to the route and the transit method;
retrieving the first extrinsic constraint from the first service, wherein the first service is provided information related to the route and the transit method; and
obtaining first information related to a first delay probability of the load based on the first extrinsic constraint.

4. The method of claim 3, wherein the first information is obtained before consignment of the load.

5. The method of claim 3, wherein the first information is obtained after consignment of the load.

6. The method of claim 2, further comprising:
obtaining a delay probability of the load based on intrinsic constraints associated with the first carrier and the transit method.

7. The method of claim 6, further comprising:
retrieving the intrinsic constraints based on a public interface or a private interface of the first carrier.

8. The method of claim 2, further comprising:
determining a modification probability of a transit reconfiguration during transit based on intrinsic constraints or extrinsic constraints.

9. The method of claim 1, further comprising:
after deploying the load based on the transit configuration, monitoring transit of the load based on the first carrier;
obtaining an in-transit delay probability and an estimated delivery date and time based on monitoring the transit of the load; and
providing a notification based on the in-transit delay probability changing.

10. The method of claim 1, further comprising:
in response to determining that the load will be delayed, identifying the at least one corrective modification to the transit configuration for the load; and
providing a notification including the at least one corrective modification.

11. The method of claim 1, wherein determining the predicted delivery date further comprises determine a predicted delivery time, and wherein the requested delivery date includes a requested delivery time.

12. A tracking management system for predicting delays, comprising:
a storage configured to store instructions;
a processor configured to execute the instructions and cause the processor to:
receive a pre-shipment notification from a customer indicating that a load will be collected from a source location and delivered to a destination location;
determine a collection date to collect the load based on a status of contents of the load;
identify a first carrier and a service level for the load based on a requested delivery date;
prior to collection of the load, determine a predicted delivery date for the load considering friction within a transit configuration for the load using the first carrier, wherein the friction is associated with at least one intrinsic constraint of the first carrier and at least one extrinsic constraint; and
in response to determining that the predicted delivery date is after the requested delivery date, identify at least one corrective modification to the transit configuration for the load.

13. The tracking management system of claim 12, wherein the processor is configured to execute the instructions and cause the processor to:
identify a route and a transit method of the transit configuration based on properties of the load, the first carrier, the service level, the source location, and the destination location; and
determine a likelihood of a delay to the load based on at least one of at least one of intrinsic constraints or extrinsic constraints, associated with the transit configuration.

14. The tracking management system of claim 13, wherein the processor is configured to execute the instructions and cause the processor to:
identify a first service related to a first extrinsic constraint corresponding to the route and the transit method;
retrieve the first extrinsic constraint from the first service, wherein the first service is provided information related to the route and the transit method; and
obtain first information related to a first delay probability of the load based on the first extrinsic constraint.

15. The tracking management system of claim 14, wherein the first information is obtained before consignment of the load.

16. The tracking management system of claim 14, wherein the first information is obtained after consignment of the load.

17. The tracking management system of claim 13, wherein the processor is configured to execute the instructions and cause the processor to:
obtain a delay probability of the load based on intrinsic constraints associated with the first carrier and the transit method.

18. The tracking management system of claim 17, wherein the processor is configured to execute the instructions and cause the processor to:
retrieve the intrinsic constraints based on a public interface or a private interface of the first carrier.

19. The tracking management system of claim 12, wherein the processor is configured to execute the instructions and cause the processor to:
determine a modification probability of a transit reconfiguration during transit based on intrinsic constraints or extrinsic constraints.

20. The tracking management system of claim 12, wherein the processor is configured to execute the instructions and cause the processor to:
after deploying the load based on the transit configuration, monitor transit of the load based on the first carrier;
obtain an in-transit delay probability and an estimated delivery date and time based on monitoring the transit of the load; and
provide a notification based on the in-transit delay probability changing.

21. The tracking management system of claim 12, wherein the processor is configured to execute the instructions and cause the processor to:
in response to determining that the load will be delayed, identify the at least one corrective modification to the transit configuration for the load; and
provide information to the first carrier to modify the transit configuration based on the at least one corrective modification.
